(19) United States
(12) Patent Application Publication
(10) Pub. No.: US 2025/0267433 A1
(43) Pub. Date: Aug. 21, 2025

(54) COMMUNICATION APPARATUS AND METHOD THEREOF

(71) Applicants: Michael Bourgoin, Pembroke (CA); Julie Hebert, Pembroke (CA)

(72) Inventors: Michael Bourgoin, Pembroke (CA); Julie Hebert, Pembroke (CA)

(21) Appl. No.: 18/583,098

(22) Filed: Feb. 21, 2024

(51) Int. Cl. H04W 4/14; G10L 15/26; H04W 4/18

(52) U.S. Cl. CPC H04W 4/14; H04W 4/18; G10L 15/26

(57) ABSTRACT

A communication apparatus and method wherein the present invention is configured to convert SMS text messages to voice data and voice data to SMS text messages in real time so as to facilitate interactive communication between a phone module and a smartphone. The present invention includes a phone module wherein the phone module in a preferred embodiment has a physical appearance of a conventional rotary phone. The phone module includes a controller that is communicably coupled to a smartphone wherein the smartphone has a software application loaded thereon operable to execute the method of the present invention. The method of the present invention includes a first mode of operation having a single audio broadcast of a SMS data packet from the smartphone via the phone module. A second mode comprises interactive communication between the smartphone and phone module converting SMS to voice and vice versa.

### FIELD OF THE INVENTION

The present invention relates generally to telephonic communications, more specifically but not by way of limitation, a telephone module wherein the telephone module is communicably coupled to a smartphone and wherein the method of the present invention includes the ability to convert SMS text messages to voice data and voice data to SMS text messages in order to receive voice data via the telephone module and further include the ability to facilitate an interactive conversation.

### BACKGROUND

Millions of people utilize smartphones on a daily basis to facilitate communication with other individuals. These communications can be voice or can be an alternative format such as but not limited to SMS messaging. While most communications can be routine daily communications between two individuals, there are certain occasions wherein the communication is centered around a special event or other circumstance. By way of example but not limitation, many people celebrate Christmas as an annual holiday. As with most holidays, Christmas has numerous traditions, one of which is a character known as Santa Claus. Santa Claus is an imaginary character that is utilized to represent the spirit of Christmas. In most households, kids under a certain age believe Santa Claus to be a real individual and as such will write letters to him expressing their wishes for the Christmas holidays. It is commonly taught that the children must be good in order to receive holiday gifts from Santa Claus.

Many children will write letters to Santa requesting various gifts or blessings for the holiday season. While letters are common, it has become popular for children to engage in telephonic or voice communications with Santa. These are typically recorded lines and they have no ability to provide an interactive conversation. These scenarios are routine for other events and/or individuals that expand beyond the scope of Christmas and the holiday season. Events such as the loss of a tooth or a deceased relative can be a scenario in which individuals such as but not limited to children desire to communicate with an entity that is fictional.

Accordingly, there is a need for a communication apparatus that is configured to be communicably coupled to a smart phone wherein the present invention facilitates interactive text to voice and voice to text communications.

### SUMMARY OF THE INVENTION

It is the object of the present invention to provide a communication apparatus and method that is configured to facilitate two way communications either real time or stored wherein the present invention includes a phone module.

Another object of the present invention is to provide a method operable to facilitate text to voice and voice to text communications wherein the phone module of the present invention includes a controller wherein the controller further includes a wireless communication module.

A further object of the present invention is to provide a communication apparatus and method that is configured to facilitate two way communications either real time or stored wherein the method of the present invention includes a step of converting a SMS text message to voice data that is stored for subsequent transmission.

Yet a further object of the present invention is to provide a method operable to facilitate text to voice and voice to text communications wherein the present invention further includes interactive voice to text communication wherein the phone module transmits data to a connected smart phone that displays the data in SMS text format.

Still another object of the present invention is to provide a communication apparatus and method that is configured to facilitate two way communications either real time or stored wherein the phone module of the present invention includes an audio input and output module.

An additional object of the present invention is to provide a method operable to facilitate text to voice and voice to text communications wherein the present invention includes the step of storing a second input of voice data for subsequent conversion into SMS data packet.

Yet a further object of the present invention is to provide a communication apparatus and method that is configured to facilitate two way communications either real time or stored wherein the present invention includes a step of providing an audio alarm on the phone module ensuing receipt of a converted text to voice data packet.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the phone module of the present invention communicably coupled to an exemplary smartphone; and

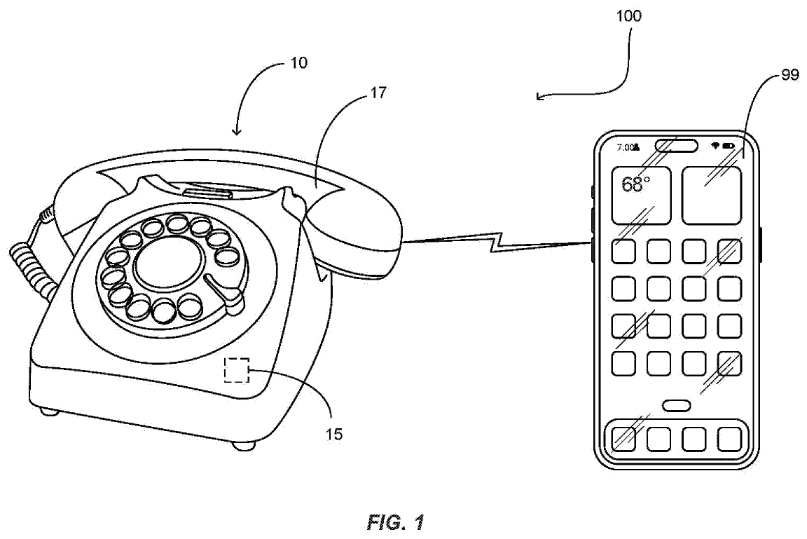

FIG. 2 is flowchart of the method of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a communication apparatus and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the communication apparatus and method 100 includes a phone module 10. In a preferred embodiment of the phone module 10 the phone module 10 is manufactured to resemble a conventional rotary phone. It should be understood within the scope of the present invention that the phone module 10 could be manufactured in to resemble alternate types of phones or communication devices. The phone module 10 includes a controller 15 that is configured to provide operation of the phone module 10. The controller 15 includes the necessary electronics to receive, store, transmit and manipulate data. The controller 15 provides the wireless communication between the phone module 10 and the exemplary smartphone 99. It should be understood within the scope of the present invention that the controller 15 utilizes wireless communication protocols such as but not limited to Bluetooth to facilitate communication between the phone module 10 and the exemplary smartphone. The phone module 10 further includes an audio input and output module 17. The audio input and output module 17 includes conventional electronic components such as but not limited to audio speakers and a microphone so as to be able to broadcast and receive as input voice data. The controller 15 is further configured to provide conversion of SMS text data, or similar data, to voice data wherein the voice data is broadcast to a user of the phone module 10. It should be understood within the scope of the present invention that the conversion of voice to SMS data and SMS to voice data could be executed by a software application stored on the smartphone 99 in place of and/or in conjunction with any data manipulation performed by the controller 15.

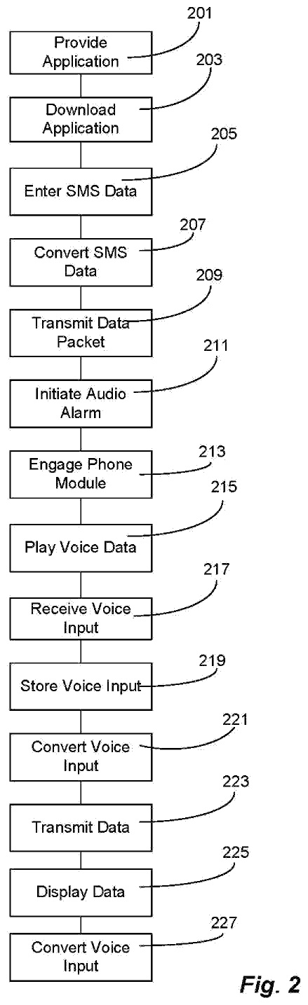

Referring now to FIG. 2 submitted as a part hereof, the method of the present invention is outlined therein. It should be understood within the scope of the present invention that the steps outlined in the method diagrammed in FIG. 2 are in an exemplary order and these steps could be executed in alternate arrangements or have some of the steps eliminated, skipped or repeated. In step 201, a provider of the communication apparatus and method 100 will make available a software application to be utilized on the exemplary smartphone 99. The software application is a conventional application that provides a graphical interface for operation of the communication apparatus and method 100. It should be understood within the scope of the present invention that the software application is made available in suitable locations such as but not limited to application stores. Step 203, subsequent purchase of the phone module 10, a user will download the application of the present invention.

In step 205, a first user will enter SMS data into the software application of the present invention. Step 207, the inputted SMS data is converted into a voice data packet and stored on the smartphone 99. In step 209, the voice data packet is transmitted utilizing wireless data protocols to the phone module 10 wherein the controller 15 provides temporary storage thereof. In step 211, subsequent receiving the voice data packet, the controller 15 will initiate an audio alarm. Step 213, a user will engage the phone module 10 wherein the user will grasp the audio input and output module 17 and separate from the phone module 10. In step 215, ensuing the audio input and output module being removed from the phone module 10, the controller 15 will facilitate broadcast of the transmitted voice data packet.

Step 217, ensuing broadcast of the voice data packet, the user engaged with the audio input and output module 17 can input voice data into the audio input and output module 17. It should be understood within the scope of the present invention that the user of the phone module 10 could cease engagement with the phone module 10 and as such terminate the method of the present invention ensuing completion of step 215. In step 219, the controller 15 temporarily stores the inputted voice data received from the audio input and output module 17 of the phone module 10. Step 221, the controller 15 converts the voice data received from the audio input and output module 17 into SMS data format. In step 223, the controller 15 facilitates the transfer of the SMS data to the smartphone 99 operably coupled with the phone module 10. Step 225, the smartphone 99 displays the SMS data to the user of the smartphone 99 for consumption thereof. In step 227, if desired a user can repeat steps 205 through 209 again so as to facilitate creation and transmission of voice data to be broadcast by the audio input and output module 17 of the phone module 10. It should be understood within the scope of the present invention that communication cycles of the communication apparatus and method 100 could be a single transmission or a plurality of transmissions back and forth between the phone module 10 and the smartphone 99.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A communication method that includes conversion of SMS data to audio and audio to SMS data to facilitate an interactive communication wherein the communication method comprises:
providing a phone module, wherein the phone module includes a controller, said controller having electronics to receive, store, transmit and manipulate data, said phone module having an audio input and output module operably coupled thereto;
publishing a software application, said software application published in a manner to be downloaded to a smartphone for use thereof;
entering SMS data into the software application of the smartphone, wherein a first user enters SMS data into the software application that is desired to be transmitted;
converting the SMS data to a voice data packet;
transmitting the voice data packet, wherein the smartphone transmits the voice data packet to the phone module;
receiving the voice data packet, wherein the phone module receives and stores the voice data packet;
engaging the phone module, wherein a second user engages the phone module to listen to the voice data packet; and
broadcasting the voice data packet, wherein the voice data packet is broadcast to the second user utilizing the audio input and output module.

2. The communication method that includes conversion of SMS data to audio and audio to SMS data to facilitate an interactive communication as recited in claim 1, and further including a step of inputting voice data into the phone module, wherein the second user inputs voice data into the audio input and output module of the phone module.

3. The communication method that includes conversion of SMS data to audio and audio to SMS data to facilitate an interactive communication as recited in claim 2, and further including a step of storing the voice data within the controller, wherein the voice data input from the audio input and output module is stored in the controller.

4. The communication method that includes conversion of SMS data to audio and audio to SMS data to facilitate an interactive communication as recited in claim 3, and further including a step of converting the voice data into a SMS data packet.

5. The communication method that includes conversion of SMS data to audio and audio to SMS data to facilitate an interactive communication as recited in claim 4, and further including a step of transmitting the SMS data packet to the smartphone.

6. The communication method that includes conversion of SMS data to audio and audio to SMS data to facilitate an interactive communication as recited in claim 5, and further including a step of displaying the SMS data in the software application on the smartphone.

7. The communication method that includes conversion of SMS data to audio and audio to SMS data to facilitate an interactive communication as recited in claim 6, and further including a step of initiating a sound alarm, wherein the controller initiates a sound alarm subsequent receipt of the voice data packet from the smartphone.

8. The communication method that includes conversion of SMS data to audio and audio to SMS data to facilitate an interactive communication as recited in claim 7, wherein the phone module is embodied as a conventional rotary phone.

9. The communication method that includes conversion of SMS data to audio and audio to SMS data to facilitate an interactive communication as recited in claim 8, wherein the present invention includes a first mode of operation and a second mode of operation, wherein in the first mode of operation the phone module receives the voice data packet and the voice data packet is broadcast via the audio input and output module.

10. The communication method that includes conversion of SMS data to audio and audio to SMS data to facilitate an interactive communication as recited in claim 9, wherein in the second mode of operation, the second user inputs voice data to be transferred to the smartphone and wherein an interactive communication ensues.
